(19) United States
(12) Patent Application Publication
(10) Pub. No.: US 2006/0156598 A1
(43) Pub. Date: Jul. 20, 2006

(54) Conveyor belt cover

(76) Inventors: Brandon Steele Johnston, Herndon, KY (US); Henry G. Lee, Newcastle, ME (US)

Correspondence Address: CHRIS A. CASEIRO, VERRILL DANA, LLP, ONE PORTLAND SQUARE, PORTLAND, ME, 04112-0586, US

(21) Appl. No.: 11/303,859

(22) Filed: Dec. 16, 2005

Related U.S. Application Data
(60) Provisional application No. 60/637,333, filed on Dec. 17, 2004.

(51) Int. Cl. G09F 11/12

(52) U.S. Cl. 40/524

(57) ABSTRACT

A checkout counter belt cover for displaying information, including advertising information. The cover is formed of a stretchable material and includes at least one printable surface. The cover is releasably attachable to a checkout counter belt such that it substantially covers the entire belt but without affecting standard belt movement. A perimeter attachment component and a width attachment component are removably affixed to the belt. One end of the cover is releasably affixed to the width attachment component. As the belt is moved, the cover is releasably affixed to the perimeter attachment component. As one rotation of the belt is completed, the opposite end of the cover is releasably affixed to the width attachment component adjacent to the one end of the cover.

### CROSS REFERENCE TO RELATED APPLICATION

The present application claims the priority benefit of U.S. provisional patent application Ser. No. 60/637,333, filed Dec. 17, 2004, entitled “CONVEYOR BELT AND COVER INFORMATION DISPLAY SYSTEM” of the same named inventors. The entire contents of that prior application are incorporated herein by reference.

### BACKGROUND OF THE INVENTION

1. Field of the Invention

The present invention relates to covers for endless and mechanically laced together belt systems. More particularly, the present invention relates to applying information to these belts, such as conveyor belts. Still more particularly, the present invention relates to conveyor belts and covers for conveyor belts including advertising.

2. Description of the Prior Art

Conveyors are used in many industries for the purpose of conveying items from one location to another with little to no physical effort by a human being to generate the conveyance. Conveyors include, generally, a web or belt of some selectable length that is retained on one or more rotational elements. The belt is looped about the rotational elements and moves when the rotational elements move. The rotational elements may be controllable pulleys, drums, or wheels. The most widely observed conveyors are used in retail stores as the means by which a plurality of products may be transferred by a consumer from a beginning to an end of a checkout platform. Of course, they may be observed in other settings, such as the “people movers,” luggage pickup, and security checkpoints located at airports. These are but two examples of the conveyors that the public may observe in their daily lives.

For the most part, conveyor belts are formed of composites of materials, such as reinforced plastic, for example. The belt surface upon which items are placed are generally of a uniform nondescript color. They must be fabricated to be tough enough to withstand the loads they experience, flexible enough to be able to pass about the rotational elements for many cycles, and relatively easy to keep clean (at least those used in public settings). Moreover, there is a desire to minimize the space that a conveyor takes up in a public setting. Making effective advertisement use of the surface of the belt observable by individuals can be problematic due to the flexible nature of the conveyor belts, the continuous wear associated with objects placed on the belts and the small diameter pulleys they must travel around.

As conveyors are observed by the consuming public on such a regular schedule, it has been contemplated that the belts may be modified to include information of potential interest for consumers to view as they purchase their products, move through the airport, etc. Various devices and methods for applying advertising in particular to conveyor belts. See, for example, U.S. Pat. No. 4,979,591 issued to Habegger et al., U.S. Pat. Nos. 5,358,094 and 6,648,127 issued to Molinaro et al., U.S. Pat. No. 5,620,061 issued to Fraser, and U.S. Pat. No. 6,082,525 issued to Vonholm et al. Each of these prior patents contemplates the option of adding advertising to endless conveyor belts observable by consumers. Each fails, however, to recognize and address the difficulties associated with providing such advertising information as an add-on cover to an existing belt, or as an integral belt cover while maintaining the original operating integrity of the belt. For example, many contemplate the use of combinations of layers of materials of differential stretch and memory characteristics. Such differential characteristics of the belt and the add-on cover produce wrinkling and distortion, which reduce information viewing, induce wear, and collect dirt. Further, they fail to recognize and address the difficulties associated with switching out and replacing advertising covers on belts in a manner that makes it relatively simple for an individual with little training to perform. A newly added cover would improve the appearance of the belt, but must be done with little to no interference to regular belt operation.

Therefore, what is needed is an apparatus and related method to apply information to endless or mechanically laced together belt systems, either of which will be referred to herein individually as a belt system or together or as a plurality of either or both in combination as belt systems. Further, what is needed is an apparatus and related method to apply a cover to an existing belt system, or to provide a cover system, with information thereon, that addresses the difficulties associated with providing such information while maintaining the operational integrity of the belt. What is also needed is such an apparatus and related method which permit the changing of the cover many times. The information may be any sort of information to be presented including, but not limited to, commercial advertising for available goods and services. Yet further, what is needed is such an apparatus and related method to provide information on an endless belt system that addresses the difficulties associated with easily switching out and replacing advertising covers or belts at any time, anywhere, by anyone.

### SUMMARY OF THE INVENTION

It is an object of the present invention to provide an apparatus and related method to apply information to belt systems. It is also an object of the present invention to provide an apparatus and related method to apply a cover to an existing belt system, or to provide a cover system, with information thereon, that addresses the difficulties associated with providing such information while maintaining and not reducing the existing operational integrity of the belt itself. It is a further object of the present invention to provide an apparatus and related method to provide information on an endless belt system that addresses the difficulties associated with easily switching out and replacing advertising covers or belts. That is, it is an object of the present invention to permit changing of the cover many times, thereby minimizing the existence of belt covers which are dirty and/or faded.

These and other objects are achieved by the present invention, which is a checkout counter belt cover for displaying information, including advertising information. The cover is formed of a stretchable material and includes at least one printable surface. The cover is releasably attachable to a checkout counter belt such that it substantially covers the entire belt but without affecting standard belt movement. A perimeter attachment component and a width attachment component are removably affixed to the belt. One end of the cover is releasably affixed to the width attachment component. As the belt is moved, the cover is releasably affixed to the perimeter attachment component. As one rotation of the belt is completed, the opposite end of the cover is releasably affixed to the width attachment component adjacent to the one end of the cover.

The invention is directed to retail conveyor belts observable in retail stores and airports but is not limited solely to those specific applications. The cover may be a belt cover or may optionally be formed and applied as a replacement belt or web of an existing conveyor system. The stretchable material may be produced to include integrally therein or thereon the information, such as an advertisement. Alternatively, such information may be applied to another substrate and the substrate removably or permanently applied to the stretchable material. When the stretchable material is used as a cover for an existing belt, an attachment component, such as the hook portion of the Velcro® hook-and-loop product, is affixed to the existing belt. The stretchable material including information thereon is removably attached to the attachment component that is on the belt. A printable surface of the stretchable material is face up and observable by consumers when the cover is in place on the belt or as the belt. The printable surface of the belt may be covered with a stain-resistant transparent protective shield, such as a polyurethane film, over the information to be displayed.

In one embodiment of the invention, a checkout counter belt cover for displaying information on a checkout counter belt is provided. The cover includes a stretchable material having a first end and a second end, wherein the stretchable material includes at least one printable surface, a first attachment means for removably affixing the stretchable material to a checkout counter belt, and a second attachment means for releasably affixing the first end of the stretchable material and the second end of the stretchable material to the checkout counter belt such that the stretchable material extends around the checkout counter belt and the first end and the second end of the stretchable material are adjacent to one another with an interface therebetween.

In another embodiment of the invention, the cover described may further include Velcro® material as the first attachment means and the second attachment means. The first attachment means is affixed to the checkout counter belt across a portion or the entirety of the length thereof and is about ⅝-inch wide, and the second attachment means is affixed to the checkout counter belt across a width thereof and is about six inches wide.

In another embodiment of the invention, the invention further includes a transparent sealing material for sealing the interface between the first end and the second end of the stretchable material. The transparent sealing material may be an epoxy.

In another embodiment of the invention, a method is provided for applying a removable informational cover to a checkout counter belt having a first perimeter length, a second perimeter length and a width, the removable informational cover formed of a stretchable material having at least one printable surface, a first end, a second end, a first perimeter length and a second perimeter length. The method includes the steps of applying a first attachment means to the checkout counter belt, the first attachment means including a first portion positioned on the first perimeter length of the checkout counter belt, and a second portion positioned on the first perimeter length of the checkout counter belt, applying a second attachment means to the checkout counter belt extending entirely or partially along the width thereof, releasably affixing the first end of the stretchable material to the second attachment means, moving the checkout counter belt while simultaneously releasably affixing the first perimeter length and the second perimeter length of the stretchable material to the first portion and second portion, respectively, of the first attachment means, and releasably affixing the second end of the stretchable material to the second attachment means such that the first end of the stretchable material and the second end of the stretchable material are adjacent to one another with an interface therebetween and the stretchable material extends around the checkout counter belt.

It has been determined that the use of the stretchable material as the cover aids in the creation of an information-disclosing apparatus that may form part of, and that stands up to the rigors of, a conveying system. Whereas non-stretchable substrates tend to wrinkle, crease, or become loose as they undergo the rotation process around the conveyor pulleys, the stretchable material does rotate as desired without such wrinkling or bunching. Elimination of wrinkling, creasing, or slackening enables easy viewing of the information presented on the belt without inhibiting belt operation. Combinations of layers of materials of differential stretch and memory characteristics are eliminated through the use of this invention.

The components of the present invention may be employed to apply a full-length advertisement on a conventional checkout counter belt. The conveyor unit may be modified to be recessed so that the addition of the stretchable material and its covering do not increase the overall height of the belt. Alternatively, as indicated, the components may be applied directly onto the existing belt system without any modification.

### BRIEF DESCRIPTION OF THE DRAWINGS

FIG. 1 is a simplified perspective view of a checkout counter including the checkout counter belt cover of the present invention.

FIG. 2 is a top view of a checkout counter belt including the first attachment component and the second attachment component of the checkout counter belt of the present invention.

FIG. 3 is a top view of a the checkout counter belt cover of the present invention showing a sealing component at the interface of the first and second ends of the cover.

FIG. 4 is a cross-sectional end view of a simplified representation of a modified endless belt showing the width of the belt and including the cover of the present invention.

### DETAILED DESCRIPTION OF THE PREFERRED EMBODIMENT

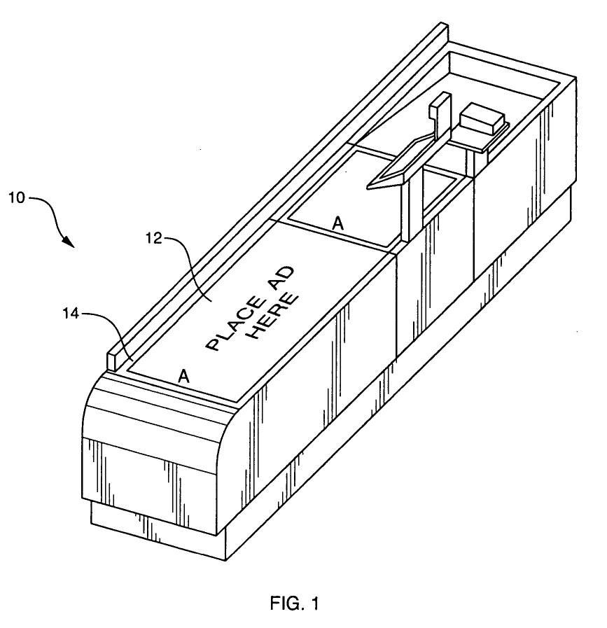

A conveyor system 10 for transporting items from one location to another, and including a removable cover 12 of the present invention is shown in FIG. 1. The conveyor system 10 may form part of a retail store checkout system, as shown, or may be some other form of conveyor visible by individuals. The cover 12 may be attached to or form an integral part of a modified endless belt 14 that forms part of the conveyor system 10. The modified endless belt 14 is rotatable about a rotation system (not shown) as the means by which products may be conveyed from point “A” to point “B” in the direction shown by the arrow. The cover 12 is configured and arranged to move with and as part of the modified endless belt 14, but without causing a disruption to the operation of the conveyor system 10, without wrinkling or creasing of the modified endless belt 14 as a whole, and without affecting the basic function of product transport. The conveyor system 10 may be of any type commercially available, such as a Pan-O-Mat™ product as available from AMF Bakery of Richmond, Va. An endless belt that forms the basis for the modified endless belt 14 may be of the type available from Maine Industrial Plastic & Rubber of Newcastle, Me.

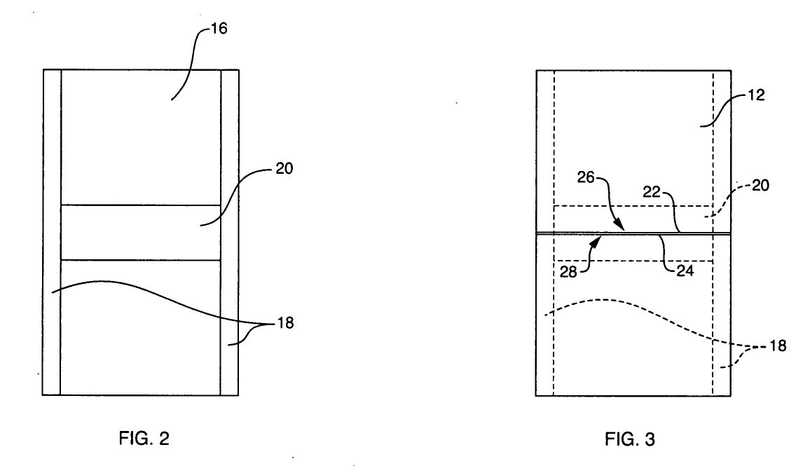

As illustrated in FIGS. 1 and 2, the cover 12 may be releasably applied to a conventional checkout counter belt 16 using a first attachment means 18 and a second attachment means 20. The first attachment means 18 is removably affixed to the checkout counter belt 16 across a portion or all of the length thereof at a first perimeter length and at a second perimeter length. The first attachment means 18 is about ⅝-inch wide. The second attachment means 20 is affixed to the checkout counter belt 16 across a width thereof. The second attachment means 20 is about six inches wide. The first attachment means as shown in FIG. 2 may be applied to both perimeter lengths of the counter belt 16. Alternatively, it may be applied to only one. The first attachment means 18 and the second attachment means 20 may be of selectable widths. They may be removably applied to the counter belt 16 by adhesive or other selected means. An epoxy adhesive is suitable for this purpose. Other means for securing the attachment means 18 and 20 to the counter belt 16, such as pressure sensitive adhesive or double-sided tape, for example, may be used in the alternative. Pressure should be applied to the attachment means 18/20 upon suitable placement on the counter belt 16, such as by pressing down with a roller or applying a uniform load. The attachment means 18/20 are preferably the type that enables repeated removable and affixation of the cover 12. For example, the attachment means 18/20 may be the “hook” portion of a Velcro® hook-and-loop system, with the underside of the cover 12 engaging or entangling with the hook portion of the attachment means 18/20 where they contact one another. It is to be understood that the present invention is directed to the application of the cover 12 to an existing belt and is not directed specifically to the manner of application of the cover 12 to the belt 16.

The cover 12 formed of a stretchable and, optionally, printable, material as described herein, may itself by covered with an optional transparent protective shield, either separately or integrally, in order to prevent fouling of the cover 12 itself and to minimize degradation of the observability of any information contained thereon.

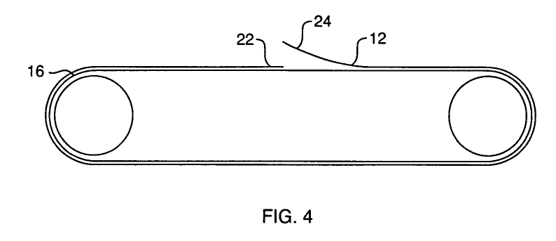

The cover 12 may be applied to the belt 16 in the following manner and with consideration of FIGS. 2-4. The first attachment means 18 and the second attachment means 20 are applied to the belt 16 as shown in FIG. 2 while the belt 16 is halted. The attachment means 18/20 may be applied to the belt in either order. The cover 12 of selectable length and including advertising or other information of choice on at least one surface, may be cut square across its width to establish a straight edge at a first end 22 thereof. The first end 22 or leading edge 22 of the cover 12 is removably attached to the second attachment means 20, overlapping approximately one-half of the width of the second attachment means 20. While applying tension to the cover 12 positioned over the belt 16 but not yet in contact with it, the belt 16 is rotated for one complete rotation, or for such other distance as is desired with respect to the overall length of the cover 12, while simultaneously removably contacting the cover 12 to the first attachment means 18.

As the second attachment means 20 rotates about on the belt 16 until returning to an observable position, such as substantially to its original position, a second end 24 or trailing edge of the cover 12 is removably contacted to the remaining exposed portion of the second attachment means 20 until matching up with the leading edge 22 at a cover ends interface 26. Preferably, the trailing edge 24 nearly abuts the leading edge 22. Alternatively, the trailing edge 24 extends beyond the interface 26, thereby overlapping the leading edge 22. The additional flap caused by the extended length may be of any desired length; however, it should not be too long or too short. For example, a flap extending approximately ⅝″ over the interface 26 would be suitable. The flap may then be cut to aid in creating a close fit between the leading edge 22 and the trailing edge 24. During or after the contacting of the cover 12 with the attachment means 18/20, pressure may be applied at least to the sites where the two are in contact. For example, pressure may be applied to the cover over the area of the attachment means 18/20, such as by pressing down with a roller or applying a uniform load. Applying pressure aids in establishment suitable attachment of the cover 12 to the attachment means 18/20 in that the hooks penetrate into the underside of the cover 12. The interface 26 may optionally be sealed with a sealing component 28. The sealing component 28 may be formed using a clear, self-leveling, fast-setting epoxy. A flexible two-part epoxy available from the Bostik™ company has been found to be suitable for this purpose. The addition of the sealing component 28 enhances the likelihood that no contaminants, including any germs, will reach to or through the cover 12 at the interface 26.

The cover 12 is preferably fabricated of a stretchable substrate material. Using Velcro® as the attachment means 18/20 enables effective attachment of the cover 12 to the belt 16 in that the Velcro® hooks become entangled with most any material. Optionally, the cover 12 may include an integral or added element on the underside thereof to enable releasable attachment to the first attachment means 18 and the second attachment means 20. That may be achieved with a double-sided tape, a pressure sensitive adhesive, or the loop portion of Velcro® material. Alternatively, the underside of the cover 12 may be roughened or “napped” at least where it is to contact the first attachment means 18 and the second attachment means 20, to further enhance undersurface roughness and assist entanglement of the Velcro® hooks with the cover 12. The upper surface (the surface observable when the cover 12 is in place on the belt 16) of the cover 12 substrate may be rough or smooth as well, but is preferably configured to be printable or have information, such as advertisements, applied and retained directly thereto. An example of a stretchable material considered suitable to be the cover 12 is a fabric such as Xymid Fabric Style 1868 available from the Xymid Corporation of Chester, Va. Other stretchable materials may also be used. The hook portion of the Velcro® product is available from the Velcro Corporation of Manchester, N.H. The transparent protective shield is preferably a clear polyurethane film that may be formed for bonding or removable attachment to the upper surface of the cover 12 after the information has been applied thereto. The polyurethane film used as transparent protective shield may be obtained from Fabrite Laminating Company of Woodbridge, N.J. The film is easy to clean and tough, with substantial resistance to piercing as products are placed on the portion of the modified endless belt 14 including the cover 12.

The cover 12 formed of a stretchable material may easily be switched to new or different information in the event another cover 12 containing different information is to be deployed. The printability of the stretchable material eliminates the need to print directly on the existing belt 16. Elimination of printing directly on the existing belt 16 eliminates the much more complex effort to replace the entire belt 16 when a change of the information observed on the conveyor system 10 is desired. Further, the stretchable material described as the material for the cover 12 has sufficient “memory” such that it can stretch going around the rotational component of the conveyor system 10, but return to its original configuration when the upper surface of the cover 12 is visible. That stretchability and memory ensure proper conveyor system 10 operation without wrinkling or creasing of the modified endless belt 14 including the cover 12, thereby eliminating distortion of the information to be observed.

A number of examples to help illustrate the invention have been described. Nevertheless, it will be understood that various modifications may be made without departing from the spirit and scope of the invention. Accordingly, other embodiments are within the scope of the claims appended hereto.

What is claimed is:

1. A checkout counter belt cover for displaying information on a checkout counter belt, the cover comprising:
a. a stretchable material having a first end and a second end, wherein the stretchable material includes at least one printable surface;
b. first attachment means for removably affixing the stretchable material to a checkout counter belt; and
c. a second attachment means for releasably affixing the first end of the stretchable material and the second end of the stretchable material to the checkout counter belt such that the stretchable material extends around the checkout counter belt and the first end and the second end of the stretchable material are adjacent to one another with an interface therebetween.

2. The checkout counter belt cover as claimed in claim 1 wherein the first attachment means is Velcro® material.

3. The checkout counter belt cover as claimed in claim 2 wherein the Velcro® material of the first attachment means is affixed to the checkout counter belt across a portion of the length thereof.

4. The checkout counter belt cover as claimed in claim 3 wherein the Velcro® material of the first attachment means is about ⅝-inch wide along each edge of the belt around its entire perimeter.

5. The checkout counter belt cover as claimed in claim 2 wherein the Velcro® material of the first attachment means is affixed to the checkout counter belt along the length thereof extending along both sides at the perimeter and conforming substantially to a length of the stretchable material.

6. The checkout counter belt cover as claimed in claim 5 wherein the Velcro® material of the first attachment means is about ⅝-inch wide.

7. The checkout counter belt cover as claimed in claim 1 wherein the second attachment means is Velcro® material.

8. The checkout counter belt cover as claimed in claim 7 wherein the Velcro® material of the second attachment means is affixed to the checkout counter belt across a width thereof.

9. The checkout counter belt cover as claimed in claim 8 wherein the Velcro® material of the second attachment means is about six inches wide.

10. The checkout counter belt cover as claimed in claim 1 further comprising a sealing material for sealing the interface between the first end and the second end of the stretchable material.

11. The checkout counter belt cover as claimed in claim 10 wherein the sealing material is an epoxy.

13. The checkout counter belt cover as claimed in claim 1 further comprising a transparent protective shield on the at least one printable surface of the stretchable material.

14. The checkout counter belt cover as claimed in claim 13 wherein the transparent protective shield is a polyurethane.

15. The checkout counter belt cover as claimed in claim 1 wherein the stretchable material is a stretchable fabric.

16. The checkout counter belt cover as claimed in claim 15 wherein the stretchable fabric is Xymid Fabric Style 1868.

17. A method for applying a removable informational cover to a checkout counter belt having a first perimeter length, a second perimeter length and a width, the removable informational cover formed of a stretchable material having at least one printable surface, a first end, a second end, a first perimeter length and a second perimeter length, the method comprising the steps of:
a. applying a first attachment means to the checkout counter belt, the first attachment means including a first portion positioned on the first perimeter length of the checkout counter belt, and a second portion positioned on the first perimeter length of the checkout counter belt;
b. applying a second attachment means to the checkout counter belt extending entirely or partially along the width thereof; and
c. releasably affixing the first end of the stretchable material to the second attachment means;
d. moving the checkout counter belt while simultaneously releasably affixing the first perimeter length and the second perimeter length of the stretchable material to the first portion and second portion, respectively, of the first attachment means; and
e. releasably affixing the second end of the stretchable material to the second attachment means such that the first end of the stretchable material and the second end of the stretchable material are adjacent to one another with an interface therebetween and the stretchable material extends around the checkout counter belt.

18. The method as claimed in claim 17 wherein the first attachment means and the second attachment means are Velcro® material.

19. The method as claimed in claim 17 further comprising the step of sealing the interface between the first end and the second end of the stretchable material.

20. The method as claimed in claim 17 further comprising the step of applying a transparent protective shield to the at least one printable surface of the stretchable material.

21. The method as claimed in claim 17 further comprising the step of applying pressure to the stretchable material where it is in contact with the first attachment means and the second attachment means.
